(19) United States
(12) Patent Application Publication
(10) Pub. No.: US 2023/0171476 A1
(43) Pub. Date: Jun. 1, 2023

(54) LENS MODULE WITH SHOCK-ABSORBENCY INBUILT AND ELECTRONIC DEVICE INCLUDING LENS MODULE

(71) Applicant: TRIPLE WIN TECHNOLOGY(SHENZHEN) CO.LTD., Shenzhen (CN)

(72) Inventors: JIAN-CHAO SONG, Shenzhen (CN); JING-WEI LI, Shenzhen (CN); DING-NAN HUANG, New Taipei (TW); SHENG-JIE DING, Shenzhen (CN)

(21) Appl. No.: 17/898,940

(22) Filed: Aug. 30, 2022

(30) Foreign Application Priority Data
Nov. 26, 2021 (CN) 202111420921.X

(51) Int. Cl. H04N 5/225

(52) U.S. Cl. CPC H04N 5/2254; H04N 5/2257

(57) ABSTRACT

A lens module with inbuilt shock-absorbency includes a carrier, a lens barrel arranged on the carrier, a lens assembly accommodated in the lens barrel, and an optical filter arranged on the carrier. The lens assembly includes a buffer member arranged on a bottom of the lens assembly facing the carrier, and a reinforcing member arranged on a side wall of the lens assembly facing the lens barrel. When the lens module is dropped or otherwise impacted, the buffer member reduces the shock of impact applied to the image sensor. The reinforcing member strengths the lens assembly, reducing a risk of loosening of the lens assembly.

### FIELD

The subject matter herein generally relates to optical devices, and more particularly to a lens module and an electronic device including the lens module.

### BACKGROUND

With miniaturization of a lens module, the back focal length of the lens module becomes limited. When the lens module is dropped or impacted, a carrier may be impacted by a lens barrel, causing breakage of an optical filter or an image sensor, resulting in failure of the lens module.

### BRIEF DESCRIPTION OF THE DRAWINGS

Implementations of the present technology will now be described, by way of embodiment, with reference to the attached figures.

FIG. 1 is a perspective view of a lens module according to an embodiment of the present disclosure.

FIG. 2 is a perspective view of a lens assembly of the lens module of FIG. 1.

FIG. 3 is an exploded view of the lens module of FIG. 1.

FIG. 4 is a cross-sectional view along line of FIG. 1.

FIG. 5 shows a result of impact-simulation of the lens module of FIG. 1.

FIG. 6 shows a result of an impact-simulation of a lens module without the buffer member and reinforcing member disclosed.

FIG. 7 is a perspective view of an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Some methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

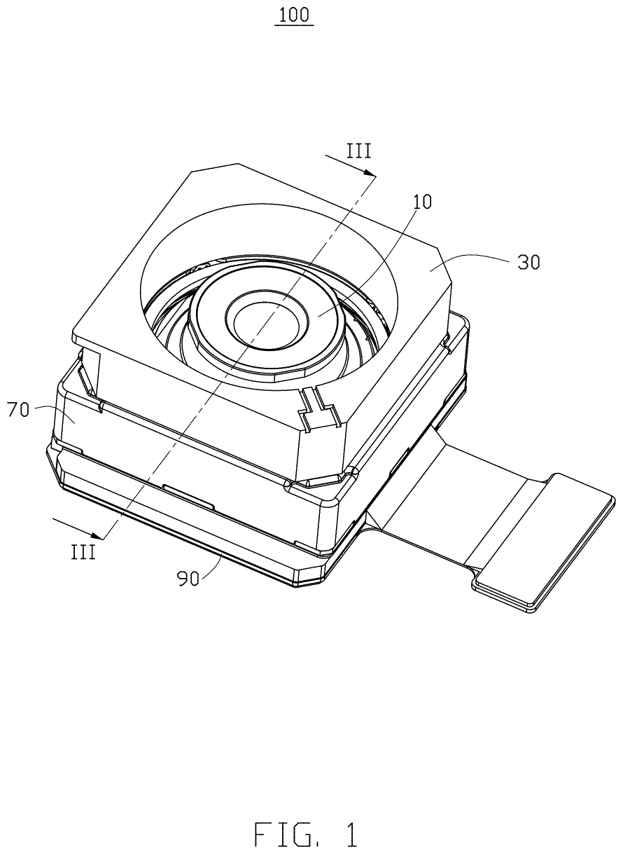

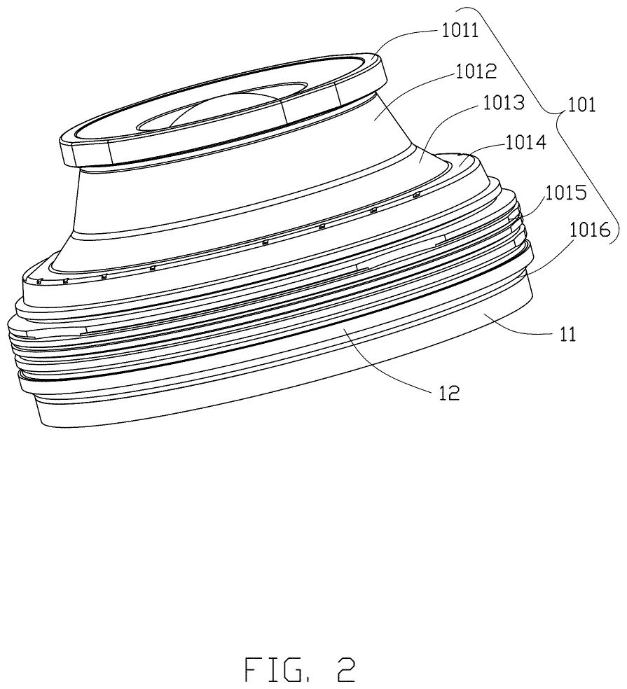

Referring to FIGS. 1 and 2, an embodiment of a lens module 100 is illustrated. The lens module 100 includes a lens assembly 10, a lens barrel 30 holding the lens assembly 10, an optical filter 50, a carrier 70, and a circuit board 90. The lens barrel 30 and the optical filter 50 are arranged on the carrier 70, and the optical filter 50 is located on an optical path of the lens assembly 10. Referring to FIGS. 2 to 4, a buffer member 11 is arranged on a bottom of the lens assembly 10 which is close to the carrier 70, and a reinforcing member 12 is arranged on a side wall of the lens assembly 10 which is close to the barrier 30.

When the lens module 100 is dropped or impacted, the buffer member 11 will absorb force and reduce the shock applied to the carrier 70, reduce an impact applied to the image sensor 50 and the lens assembly 10. Thus, a risk of breakage of the optical filter 50 and the lens assembly 10 is reduced. The reinforcing member 12 is annular and sleeved on the side wall of the lens assembly 10, fixing the lens assembly 10 and improving a structural strength of the lens assembly 10, so as to reduce a risk of loosening and failure of the lens assembly 10.

Referring to FIG. 2, the lens assembly 10 includes a main body 101, the buffer member 11, and the reinforcing member 12. The buffer member 11 and the reinforcing member 12 are arranged on the main body 101. The main body 101 includes a first lens portion 1011, a second lens portion 1012, a third lens portion 1013, a fourth lens portion 1014, a fifth lens portion 1015, and a sixth lens portion 1016 which are sequentially arranged. Diameters of the second lens portion 1012, the third lens portion 1013, the fourth lens portion 1014, and the fifth lens portion 1015 are successively increased, a diameter of the first lens portion 1011 is larger than that of the second lens portion 1012. In one embodiment, from the first lens portion 1011 to the second lens portion 1012, a diameter of the second lens portion 1012 gradually increases, and a diameter of the third lens portion 1013 gradually increases.

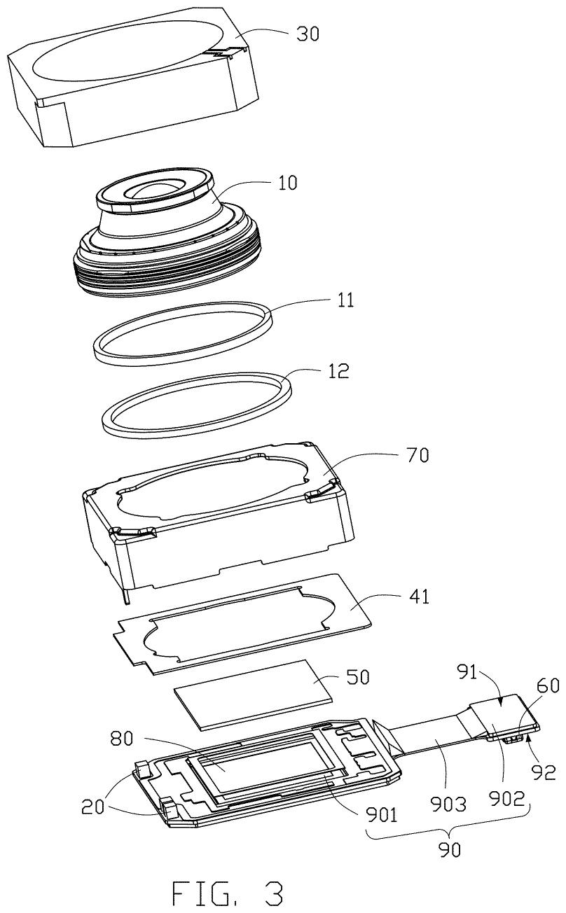

Referring to FIGS. 2 and 3, the buffer member 11 is annular. Compared with other lens portions, the sixth lens portion 1016 is closest to the carrier 70. The buffer member 11 is arranged on a bottom of the sixth lens portion 1016. If the fifth lens portion 1015 is closer to the carrier 70 than other lens portions, the buffer member 11 is arranged on a bottom of the fifth lens portion 1015. The reinforcing member 12 is arranged on a side wall of the fifth lens portion 1015. In other embodiments, the reinforcing member 12 may be arranged on a side wall of other lens portions, such as a side wall of the fourth lens portion 1014.

In one embodiment, the lens assembly 10 is made by two-color injection molding. That is, the main body 101, the buffer member 11, and the reinforcing member 12 are integrally formed by two-color injection molding. A material of the main body 101 may be, but is not limited to, polycarbonate (PC).

The circuit board 90 may be a flexible board, a rigid board, or a flexible-rigid board. In one embodiment, the circuit board 90 is a flexible-rigid board, and includes a first rigid board portion 901, a second rigid board portion 902, and a flexible board portion 903 located between the first rigid board portion 901 and the second rigid board portion 902. The circuit board 90 further includes a first surface 91 which is close to the carrier 70 and a second surface 92 which is away from the carrier 70. A plurality of electronic components 20 are mounted on the first surface 91 of the first rigid board portion 901. The carrier 70 is fixed on the first surface 91 of the first rigid board portion 901 through a first adhesive layer 41. The carrier 70 and the electronic components 20 are located on the same surface of the circuit board 90. The electronic components 20 may be, but are not limited to, passive components such as resistors, capacitors, diodes, triodes, relays, Electrically Erasable Programmable Read Only Memory (EEPROM) device.

The lens barrel 30 and the carrier 70 are hollow and rectangular. The lens barrel 30 may be fixed on the carrier 70 through a second adhesive layer (not shown). The lens barrel 30 may be made of metal or plastic. In one embodiment, the lens barrel 30 is made of aluminium alloy.

Referring to FIG. 3, an electrical connection portion 60 is arranged on the second surface 92 of the second rigid board portion 902. The electrical connection portion 60 and the electronic components 20 are located on opposite surfaces of the circuit board 90. The electrical connection portion 60 may be, but is not limited to, a golden finger connector.

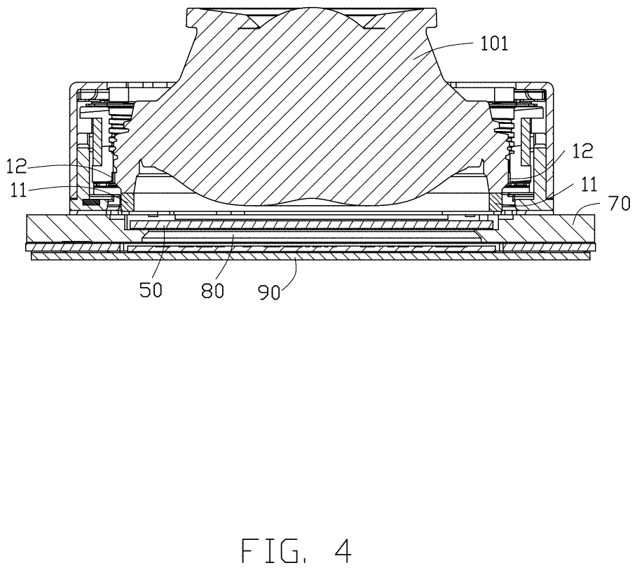

Referring to FIGS. 3 and 4, the lens module 100 further includes an image sensor 80. The image sensor 80 is mounted on the first surface 91 of the first rigid board portion 901. The image sensor 80 and the electronic components 20 are located on the same surface of the circuit board 90. The image sensor 80 corresponds to a position of the optical filter 50. Specifically, the optical filter 50 is arranged between the lens assembly 10 and the image sensor 80 and is fixed on the carrier 70 by a third adhesive layer (not shown). The optical filter 50 is configured to filter out infrared light to improve imaging quality.

In one embodiment, the buffer member 11 may be made of, but is not limited to, thermoplastic elastomers (TPE). The TPE is a soft rubber with good elasticity and flexibility. When the lens module 100 is dropped or impacted, the TPE will absorb some impact to provide buffer for the optical filter 50, the image sensor 80, and the lens assembly 10, reducing the risk of breakage.

In one embodiment, the buffer member 11 has a Shore hardness of 10° to 30°, which provides effective buffer for the optical filter 50, the image sensor 80, and the lens assembly 10.

In one embodiment, a material of reinforcing member 12 may include but is not limited to polycarbonate (PC), polystyrene (PS), acrylonitrile butadiene styrene plastic (ABS plastic), acrylonitrile styrene resin (AS), or polyvinyl chloride (PVC).

In one embodiment, the reinforcing member 12 has a Shore hardness of 50° to 80°, which improves a structural strength of the lens assembly, and reduces the risk of loosening of the lens assembly 10. In one embodiment, the reinforcing member 12 has a Shore hardness of 70°.

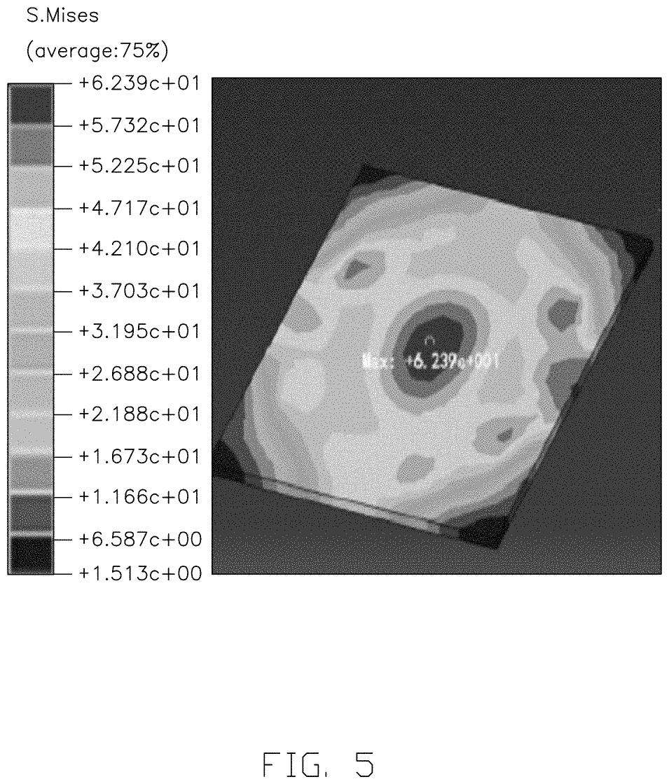

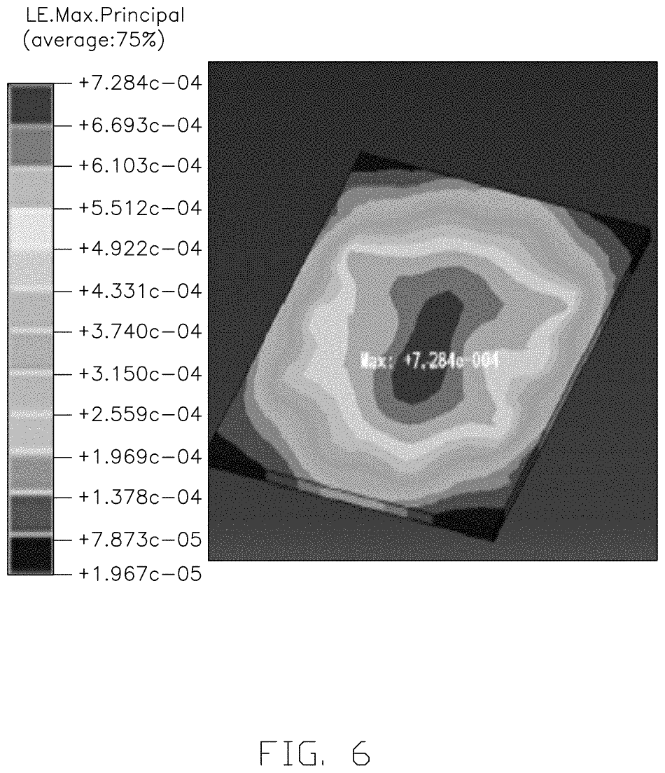

An impact-simulation test is performed on the lens module 100 shown in FIG. 1, and a test result is shown in FIG. 5. When the buffer member 11 and the reinforcing member 12 of the lens module 100 shown in FIG. 1 are omitted, an impact-simulation test is performed on such lens module, and a test result is shown in FIG. 6. It is can be seen from FIGS. 5 and 6, when the buffer member 11 and the reinforcing member 12 are arranged in the lens module 100, an impact applied to the image sensor 80 is reduced, and an impact distribution is more uniform. Thus, a risk of breakage of the image sensor 80 and the optical filter 50 is reduced, and the structural strength of the main body 101 of the lens assembly 10 is strengthened.

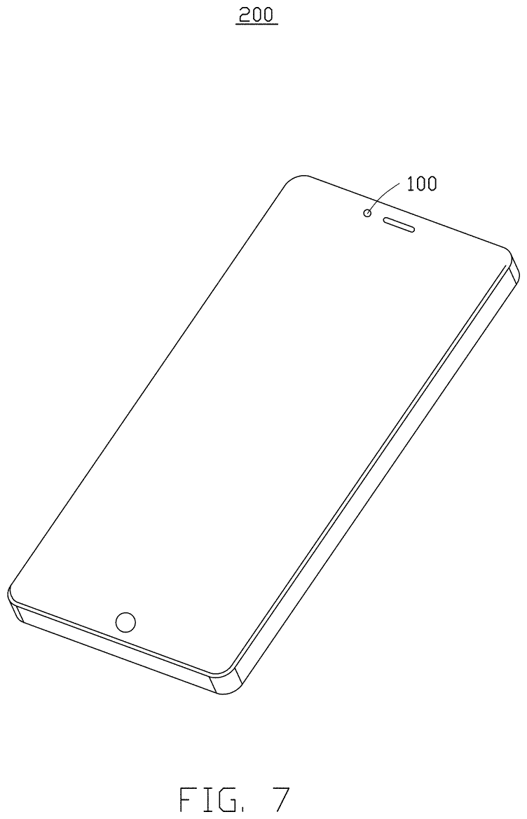

Referring to FIG. 7, an embodiment of an electronic device 200 is illustrated. The electronic device 200 includes the lens module 100. The electronic device 200 can be any electronic device having imaging capturing functions, such as mobile phones, wearable devices, computer devices, vehicles, or monitoring devices. In an alternative embodiment, the electronic device 200 is a mobile phone.

While the present disclosure has been described with reference to particular embodiments, the description is illustrative of the disclosure and is not to be construed as limiting the disclosure. Those of ordinary skill in the art can make various modifications to the embodiments without departing from the scope of the disclosure as defined by the appended claims.

What is claimed is:

1. A lens module comprising:
a carrier;
a lens barrel arranged on the carrier;
a lens assembly accommodated in the lens barrel and comprising:
a buffer member arranged on a bottom of the lens assembly facing the carrier; and
a reinforcing member arranged on a side wall of the lens assembly facing the lens barrel; and
an optical filter arranged on the carrier.

2. The lens module of claim 1, wherein a material of the buffer member comprises thermoplastic elastomer.

3. The lens module of claim 1, wherein a material of the reinforcing member comprises polycarbonate, polystyrene, acrylonitrile butadiene styrene plastic, acrylonitrile styrene resin, or polyvinyl chloride.

4. The lens module of claim 1, wherein the lens assembly further includes a main body accommodated in the lens barrel, the buffer member is arranged on a bottom of main body facing the carrier, the reinforcing member is arranged on a side wall of the main body facing the lens barrel.

5. The lens module of claim 4, wherein the main body, the buffer member, and the reinforcing member are formed as an integral unit.

6. The lens module of claim 4, wherein the reinforcing member is annular and sleeved on the side wall of the main body.

7. The lens module of claim 4, wherein the buffer member is annular.

8. The lens module of claim 1, further comprising a circuit board, a plurality of electronic components, and an electrical connection portion, wherein the circuit board comprises a first rigid board portion, a second rigid board portion, and a flexible board portion located between the first rigid board portion and the second rigid board portion, the plurality of electronic components are arranged on the first rigid board portion, the electrical connection portion is arranged on the second rigid board portion, and the plurality of electronic components and the electrical connection portion are located on opposite surfaces of the circuit board.

9. The lens module of claim 8, further comprising an image sensor arranged on the first rigid board and corresponding to a position of the optical filter.

10. The lens module of claim 8, wherein the electrical connection portion comprises a golden finger connector.

11. An electronic device comprising a lens module, the lens module comprising:
a carrier;
a lens barrel arranged on the carrier;
a lens assembly accommodated in the lens barrel and comprising:
a buffer member arranged on a bottom of the lens assembly facing the carrier; and
a reinforcing member arranged on a side wall of the lens assembly facing the lens barrel; and
an optical filter arranged on the carrier.

12. The electronic device of claim 11, wherein a material of the buffer member comprises thermoplastic elastomer.

13. The electronic device of claim 11, wherein a material of the reinforcing member comprises polycarbonate, polystyrene, acrylonitrile butadiene styrene plastic, acrylonitrile styrene resin, or polyvinyl chloride.

14. The electronic device of claim 11, wherein the lens assembly further includes a main body accommodated in the lens barrel, the buffer member is arranged on a bottom of main body facing the carrier, the reinforcing member is arranged on a side wall of the main body facing the lens barrel.

15. The electronic device of claim 14, wherein the main body, the buffer member, and the reinforcing member are formed as an integral unit.

16. The electronic device of claim 14, wherein the reinforcing member is annular and sleeved on the side wall of the main body.

17. The electronic device of claim 14, wherein the buffer member is annular.

18. The electronic device of claim 11, wherein the lens module further comprises a circuit board, a plurality of electronic components, and an electrical connection portion, the circuit board comprises a first rigid board portion, a second rigid board portion, and a flexible board portion located between the first rigid board portion and the second rigid board portion, the plurality of electronic components are arranged on the first rigid board portion, the electrical connection portion is arranged on the second rigid board portion, and the plurality of electronic components and the electrical connection portion are located on opposite surfaces of the circuit board.

19. The electronic device of claim 18, wherein the lens module further comprises an image sensor arranged on the first rigid board and corresponding to a position of the optical filter.

20. The electronic device of claim 18, wherein the electrical connection portion comprises a golden finger connector.
